(19) United States
(12) Patent Application Publication
(10) Pub. No.: US 2008/0080340 A1
(43) Pub. Date: Apr. 3, 2008

(54) Optical pickup unit capable of preventing a laser diode from destroying from static electricity

(75) Inventors: Takahiko Nishiyama, Tokyo (JP); Hideki Miura, Yamagata (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Mitsumi Electric Co. Ltd., Tama-shi (JP)

(21) Appl. No.: 11/906,508

(22) Filed: Oct. 2, 2007

(30) Foreign Application Priority Data
Oct. 2, 2006 (JP) 2006-270321

(51) Int. Cl. G11B 7/002

(52) U.S. Cl. 369/44.37; 720/600

(57) ABSTRACT

An optical pickup unit includes an optical base and at least one laser diode mounted on an outer wall of the optical base. The laser diode has a base portion, and an LD terminal and a GND terminal which extend from the base portion to a rear surface side. Formed on a short-land flexible printed board, conductive patterns enable to short-circuit the LD terminal and the GND terminal of the laser diode at a position apart from the LD terminal.

This application is based upon and claims the benefit of priority from Japanese patent application JP 2006-270321, filed on Oct. 2, 2006, the disclosure of which is incorporated herein in its entirety by reference.

### BACKGROUND OF THE INVENTION

This invention relates to an optical pickup unit and, in particular, to a three-wavelength holding optical pickup unit which is enable to carry out recording or reproducing for three kinds of optical discs by selectively using three kinds of laser beams having different wavelengths.

As well know in the art, an optical disc drive is a device for reading/writing information from/into an optical disc (CD, CD-ROM, CD-R/RW, DVD-ROM, DVD±R/RW, Blu-ray disc, HD-DVD, or the like). In order to achieve reading/writing the information from/into the optical disc, the optical disc drive of this type comprises an optical pickup unit for irradiating a laser beam onto the optical disc and for detecting its reflected beam.

In the manner which is well known in the art, in DVD apparatuses, there is one in which a particular optical pickup unit is mounted in order to enable to record/reproduce data in/from both of a digital versatile disc (DVD) and a compact disc (CD). The particular optical pickup unit of the type is for carrying out recording or reproducing by selectively using two kinds of laser beams, namely, a laser beam having a short wavelength (a wavelength band of 650 nm) for the DVD and a laser beam having a long wavelength (a wavelength band of 780 nm) for the CD. The particular optical pickup unit is called a two-wavelength handling optical pickup unit.

One of the two-wavelength handling optical pickup units of the type described comprises a first laser diode (LD) for emitting or irradiating the laser beam (a first laser beam) having the short wavelength for the DVD and a second laser diode (LD) for emitting or irradiating the laser beam (a second laser beam) having the long wavelength for the CD. Such a two-wavelength handling optical pickup unit is disclosed in Japanese Unexamined Patent Application Publication No. 2003-173563 or JP-A 2003-173563.

However, if the first laser diode and the second laser diode are formed as separate parts, it is inconvenient that the two-wavelength handling optical pickup unit comprises a lot of parts and is large-scale. In order to cope with such problems, a new laser diode comprising, as one part (one chip), the first laser diode and the second laser diode is developed and proposed, for example, in Japanese Unexamined Patent Application Publication No. 11-149652 or JP-A 11-149652. Such a new laser diode is called a one-chip type laser diode. It is possible to miniaturize the two-wavelength handling optical pickup unit by using the one-chip type laser diode. Inasmuch as the one-chip type laser diode has a first emission point for emitting the first laser beam and a second emission point for the second laser beam that are apart from each other by a predetermined distance of, for example, 100 μm, the first laser beam and the second laser beam are emitted or irradiated in parallel with they apart from each other by the predetermined distance.

Furthermore, in recent DVD apparatuses, it has been developed one in which a special optical pickup unit is mounted in order to enable to record/reproduce data in/from not only the DVD and the CD but also a high definition DVD (HD-DVD). The special optical pickup unit of the type is for carrying out recording or reproducing by selectively using three kinds of laser beams, namely, a laser beam having a middle wavelength (a wavelength band of 650 nm) for the DVD, a laser beam having a long wavelength (a wavelength band of 780 nm) for the CD, and a laser beam having a short wavelength (wavelength band of 410 nm) for the HD-DVD. The special optical pickup unit is called a three-wavelength handling optical pickup unit.

Such a three-wavelength handling optical pickup unit may use the one-chip type laser diode (a two-wavelength one-package laser diode) for the CD and the DVD such as is disclosed in the above-mentioned JP-A 11-149652 and a blue laser diode for the HD-DVD. In addition, the HD-DVD will hereafter be also abbreviated as HD.

In general, an optical pickup unit comprises a laser beam source for irradiating a laser beam and an optical system for guiding the irradiated laser beam to an optical disc and for guiding its reflected beam to a photodetector. The optical system includes an objective lens disposed so as to face the optical disc. The laser beam source and the photodetector are mounted on an outer side wall of an optical base while the optical system except for the objective lens is mounted in the optical base.

It is necessary for the objective lens used in the optical pickup unit to accurately control in position with respect to a focus direction along an optical axis and a track direction along a radial direction of the optical disc to thereby accurately focus the laser beam on a track of a signal recording surface of the rotating optical disc. These controls are called a focusing control and a tracking control, respectively. Further, following improvement in recording density, there have recently been increasing demands for removing or suppressing the influence caused by warping of the optical disc. In view of this, it is also necessary that the objective lens be subjected to a so-called tilting control.

An optical pickup actuator is a device for enabling the focusing control, the tracking control, and the tilting control. The optical pickup actuator is called an objective lens driving device. In the objective lens driving device, an objective lens holder holding the objective lens is elastically supported by a suspension member with respect to a damper base. The suspension member consists of a plurality of suspension wires disposed both sides of the damper base and the objective lens holder (see, for example, Japanese Unexamined Patent Application Publication No. 2003-196865 or JP-A 2003-196865).

Now, the objective lens driving devices are classified into a so-called symmetry type and a so-called asymmetry type. The objective lens driving devices of the symmetry type are ones wherein coils and a magnetic circuit including magnets are symmetrically disposed with respect to the objective lens as a center. The objective lens driving devices of the asymmetry type are ones wherein the coils and the magnetic circuit including magnets are asymmetrically disposed with respect to the objective lens.

One of the objective lens driving devices of the symmetry type is disclosed, for example, in Japanese Unexamined Patent Application Publication No. 2001-93177 or JP-A 2001-93177. According to the JP-A 2001-93177, the objective lens driving device of the symmetry type comprises an objective lens holder for holding an objective lens, a focusing coil wound around the objective lens holder, tracking coils affixed to the objective lens holder at outer sides in a tangential direction of an optical disc, and tilting coils affixed to the objective lens holder at both sides in a radial direction of the optical disc. These coils are partly located in gaps of the magnetic circuit. With this structure, the objective lens driving device of the symmetry type is capable of finely controlling a position and an inclination of the objective lens by controlling currents flowing through the respective coils. In addition, inasmuch as it is necessary to affix the tracking coils and the tilting coils to the sides of the objective lens holder, each of the tracking coils and the tilting coils comprises an air-core coil.

In the objective lens driving device of the symmetry type, the suspension member (the plurality of suspension wires) is provided so as to maintain horizontality in an inactive state. Specifically, the objective lens driving device is divided into a movable portion including the objective lens holder for holding the objective lens and a fixed portion including the damper base. The movable portion is elastically supported by the suspension member (the plurality of suspension wires) with respect to damper base. The suspension member (the plurality of suspension wires) is disposed so as to extend in parallel with a horizontal plane between the damper base and the objective lens holder.

Incidentally, the blue laser diode is very expensive and has the property of extreme static-sensitive. Therefore, there is a problem where the blue laser diode is destroyed caused by static electricity.

In order to protect the blue laser diode, following measures are taken previously. Specifically, during between a time instant where the blue laser diode is mounted on an outer wall of the optical base and a time instant where the blue laser diode is electrically connected to a laser diode driver LDD of an OPU circuit board, an LD terminal and a GND terminal of the blue laser diode are short-circuited using solder. After the blue laser diode and the laser diode driver LDD are electrically connected to each other, the LD terminal and the GND terminal of the blue laser diode are opened by melting the solder and sucking the solder.

However, such a handling method is disadvantageous in that it can have a detrimental effect on the blue laser diode because heat transfers to the LD terminal of the blue laser diode on applying or melting the solder.

In addition, inasmuch as the LD terminal of the blue laser diode is put into an external exposed state after the blue laser diode is mounted on the outer wall of the optical base, it is feared that a person (a worker) is directly in contact with the LD terminal of the blue laser diode on dealing with the optical pickup unit. As a result, there is a possibility that the blue laser diode destroys because of effect of static electricity accumulated in the person (the worker).

The above-mentioned phenomenon where the laser diode destroys from the static electricity may occur in the above-mentioned one-chip type laser diode (the two-wavelength one-package laser diode) as well as the blue laser diode.

### SUMMARY OF THE INVENTION

It is therefore an object of the present invention to provide an optical pickup unit which is capable of preventing a laser diode from destroying from static electricity.

Other objects of this invention will become clear as the description proceeds.

On describing the gist of this invention, it is possible to be understood that an optical pickup unit (OPU) comprises an optical base and at least one laser diode (LD) mounted on an outer wall of the optical base. The laser diode comprises a base portion and an LD terminal and a GND terminal which extend from the base portion to a rear surface side. According to an aspect of this invention, the afore-mentioned optical pickup unit comprises a short-land printed board on which conductive patterns are formed. The conductive patterns enable to short-circuit between the LD terminal and the GND terminal of the laser diode using solder at a position apart from the LD terminal.

In the afore-mentioned optical pickup unit, the optical pickup unit comprises an OPU circuit board mounted on the optical base and an LD flexible printed board for electrically connecting the LD terminal and the GND terminal of the laser diode with the OPU circuit board. In this event, the short-land printed board may be disposed between the base portion of the laser diode and the LD flexible printed board. The optical pickup unit further may comprise a first reinforcing plate lying between the base portion of the laser diode and the short-land flexible printed board and a second reinforcing plate lying between the short-land flexible printed board and the LD flexible printed board. Preferably, the optical pickup unit further may comprise a side cover for covering the laser diode so as to be directly not contact with the LD terminal of the laser diode. Desirably, the optical pickup unit may comprise a LD holder for holding the laser diode to mount the laser diode on the outer wall of the optical base and a radiating resin applied among the LD holder, the side cover, and the optical base. The optical pickup unit may comprise a three-wavelength holding optical pickup unit which is enable to carry out recording or reproducing for three kinds of optical recoding media by selectively using three kinds of laser beams having different wavelengths.

### BRIEF DESCRIPTION OF THE DRAWINGS

FIG. 1 is a system configuration view of an optical system of a three-wavelength handling optical pickup unit according to an embodiment of this invention;

FIG. 2 is a view showing a structure of a photodetector used in the three-wavelength handling optical pickup unit illustrated in FIG. 1;

FIG. 3 is a perspective view of the three-wavelength handling optical pickup unit illustrated in FIG. 1;

FIG. 4 is a perspective view of the three-wavelength handling optical pickup unit illustrated in FIG. 1;

FIG. 5 is a perspective view of the three-wavelength handling optical pickup unit illustrated in FIG. 1;

FIG. 6 is an exploded perspective view of the thee-wavelength handling optical pickup unit illustrated in FIG. 4;

FIG. 7 is an exploded perspective view of a combination of a short-land flexible printed board, an LD flexible printed board, and first and second reinforcing plates for use in the three-wavelength handling optical unit illustrated in FIG. 6;

FIG. 8 is a plan view of the short-land flexible printed board for use in the three-wavelength handling optical pickup unit illustrated in FIG. 6; and

FIG. 9 is a plan view of the LD flexible printed board for use in the three-wavelength handling optical pickup unit illustrated in FIG. 6.

### DESCRIPTION OF THE PREFERRED EMBODIMENT

In the manner which is described above, in optical disc drives, it has been developed one in which a special optical pickup unit is mounted in order to enable to record/reproduce data in/from not only the DVD and the CD but also a high definition DVD (HD-DVD). The special optical pickup unit of the type is for carrying out recording or reproducing by selectively using three kinds of laser beams, namely, a laser beam having a middle wavelength (a wavelength band of 650 nm) for the DVD, a laser beam having a long wavelength (a wavelength band of 780 nm) for the CD, and a laser beam having a short wavelength (a wavelength band of 410 nm) for the HD-DVD. The special optical pickup unit is called a three-wavelength handling optical pickup unit.

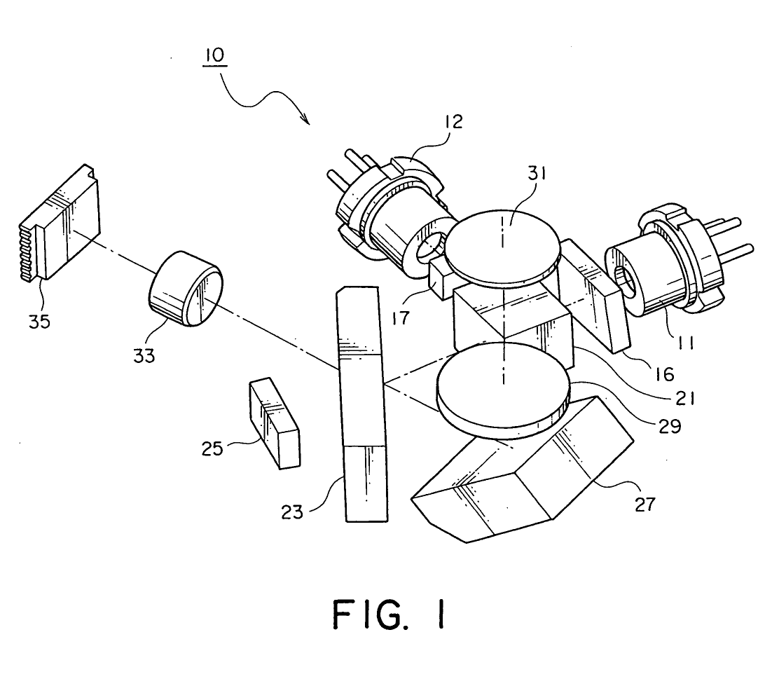

FIG. 1 is a system configuration view of an optical system of the three-wavelength handling optical pickup unit depicted at 10 according to an embodiment of this invention. The illustrated three-wavelength handling optical pickup unit 10 comprises, as laser sources for irradiating leaser beams, a one-chip type laser diode 11 and a blue laser diode 12.

The one-chip type laser diode 11 comprises, as one part (one chip), a first laser diode (not shown) and a second laser diode (not shown). The first laser diode (a first emission point) and the second laser diode (a second emission point) are apart from each other by a predetermined distance of, for example, 100 μm. The first laser diode is a laser diode for emitting or irradiating a first laser beam having, as a first wavelength, a wavelength of about 780 nm for the CD. The first laser diode is called a “CD-LD” for short. The second laser diode is a laser diode for emitting or irradiating a second laser beam having, as a second wavelength, a wavelength of about 650 nm for the DVD. The second laser diode is called a “DVD-LD” for short. The blue laser diode 12 is called a third laser diode which is a laser diode for emitting or irradiating a third laser beam having, as a third wavelength, a wavelength of about 410 nm for the HD-DVD (HD). The third laser diode is called a “HD-LD” for short.

The three-wavelength handling optical pickup unit 10 comprises an optical system for guiding any one of the first through the third laser beams to an optical disc (not shown) and for guiding its reflected beam to a photodetector 35 (which will later be described). In addition, the optical system includes an objective lens 31 disposed so as to face the optical disc. The laser beam sources 11, 12 and the photodetector 35 are mounted on an outer side wall of an optical base (which will later be described) while the optical system except for the objective lens 31 is mounted in the optical base.

On the other hand, the objective lens 31 is mounted in an objective lens driving device (an optical pickup actuator) which will later be described. In the manner which will later be described, the objective lens driving device elastically supports an objective lens holder holding the objective lens 31 by a plurality of suspension wires with respect to a damper base.

The illustrated three-wavelength handling optical pickup unit 10 comprises, as the optical system, first and second diffraction gratings 16 and 17, a first beam splitter 21, a second beam splitter 23, a front monitor 25, a rising mirror (a total reflection mirror) 27, a collimator lens 29, the above-mentioned objective lens 31, and a sensor lens (detection lens) 33.

A combination of the first diffraction grating 16, the first beam splitter 21, the second beam splitter 23, the rising mirror 27, the collimator lens 29, the objective lens 31, and the sensor lens 33 serves as first or second optical systems for guiding the first or the second laser beams irradiated from the first or the second laser diodes to the optical disc (the CD or the DVD) and for transmitting first or second return beams reflected from the optical disc to guide the photodetector 35. Likewise, a combination of the second diffraction grating 17, the first beam splitter 21, the second beam splitter 23, the rising mirror 27, the collimator lens 29, the objective lens 31, and the sensor lens 33 serves as a third optical system for guiding the third laser beam irradiated from the blue laser diode (the third laser diode) 12 to the optical disc (the HD-DVD) and for transmitting a third return beam reflected from the optical disc to guide the photodetector 35.

The blue laser diode (the third laser diode) 12 is disposed in a center of an optical axis and the second laser diode in the one-chip type laser diode 11 is disposed in the center of the optical axis. Accordingly, the first laser diode in the one-chip type laser diode 11 is disposed at a state shifted from the optical axis. Therefore, the illustrated photodetector 35 is composed so as to receive the first return beam from the CD with it shifted from the optical axis.

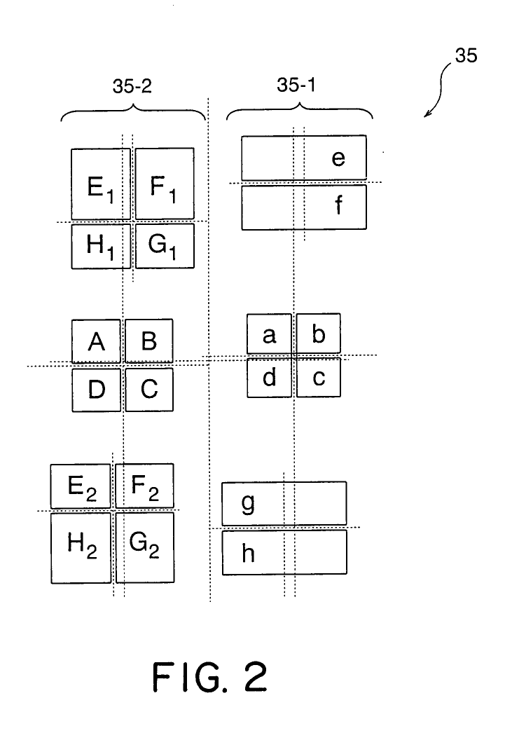

FIG. 2 shows a structure of the photodetector 35 used in the three-wavelength handling optical pickup unit 10 illustrated in FIG. 1. The photodetector 35 comprises a first receiving portion 35-1 for receiving the first return beam and a second receiving portion 35-2 for receiving the second or the third return beams. The first receiving portion 35-1 comprises four divided photo-diodes a, b, c, and d for receiving a central ray bundle (a main beam) and four photo-diodes e, f, g, and h for receiving both side two ray bundles (two sub-beams). The second receiving portion 35-2 comprises four divided photo-diodes A, B, C, and D for receiving a central ray bundle (a main beam), a first set of four photo-diodes E₁, F₁, G₁, and H₁ for receiving a first sub-beam (a leading sub-beam), and a second set of four photo-diodes E₂, F₂, G₂, and H₂ for receiving a second sub-beam (a trailing sub-beam).

Now, description will be made as regards operation of the three-wavelength handling optical pickup unit 10 illustrated in FIG. 1. In the manner which is well known in the art, although the three-wavelength handling optical pickup unit 10 is operable at one of a writing mode and a reproducing mode, the description will be made as regards operation in a case of the reproducing mode.

First, description will be made as regards operation in a case where the CD is used as the optical disc. In this event, only the first laser diode (CD-LD) in the one-chip type laser diode 11 is put into an active state while the second laser diode (DVD-LD) in the one-chip type laser diode 11 and the blue laser diode (the third laser diode) 12 (HD-LD) are put into an inactive state.

The first laser beam irradiated from the first laser diode (CD-LD) passes through the first diffraction grating 16 at which the first laser beam is separated to three laser beams in order to carry out a tracking control, a focusing control, and a tilting control. Thereafter, the three laser beams pass through the first beam splitter 21 and enter the second beam splitter 23 as incoming beams. In the incoming beams, a part passes through the second beam splitter 23 and its through-beam is received by the front monitor 25. At any rate, the front monitor 25 monitors a light-emitting amount of the first laser beam which passes through the second beam splitter 23. On the other hand, in the incoming beams, a reflected beam, which is reflected by the second beam splitter 23, is reflected by the rising mirror 27 upward. When the laser beam reflected by the rising mirror 27 passes through the collimator lens 29, the laser beam, which is a diverged beam, is collimated into a collimated beam. The collimated beam enters the objective lens 30. Passed through the objective lens 30, the laser beam is converged and irradiated on a signal recording surface of the optical disc (the CD).

Reflected by the signal recording surface of the optical disc (the CD), a reflected beam (the first return beam) passes through the objective lens 31 and becomes a converged beam after passing through the collimator lens 29. After reflected by the rising mirror 27, the converged beam passes through the second beam splitter 23. After passing through the sensor lens 33, the converted beam is detected by the first receiving portion 35-1 (FIG. 2) of the photodetector 35.

Secondly, description will be made as regards operation in a case where the DVD is used as the optical disc. In this event, only the second laser diode (DVD-LD) in the one-chip type laser diode 11 is put into an active state while the first laser diode (CD-LD) in the one-chip type laser diode 11 and the blue laser diode (the third laser diode) 12 (HD-LD) are put into an inactive state.

The second laser beam irradiated from the second laser diode (DVD-LD) passes through the first diffraction grating 16. Thereafter, the second laser beam passes through the first beam splitter 21 and enters the second beam splitter 23 as an incoming beam. In the incoming beam, a part passes through the second beam splitter 23 and its through-beam is received by the front monitor 25. At any rate, the front monitor 25 monitors a light-emitting amount of the second laser beam which passes through the second beam splitter 23. On the other hand, in the incoming beam, a reflected beam, which is reflected by the second beam splitter 23, is reflected by the rising mirror 27 upward. When the laser beam reflected by the rising mirror 27 passes through the collimator lens 29, the laser beam, which is a diverged beam, is collimated into a collimated beam. The collimated beam enters the objective lens 30. Passed through the objective lens 30, the laser beam is converged and irradiated on a signal recording surface of the optical disc (the DVD).

Reflected by the signal recording surface of the optical disc (the DVD), a reflected beam (the first second beam) passes through the objective lens 31 and becomes a converged beam after passing through the collimator lens 29. After reflected by the rising mirror 27, the converged beam passes through the second beam splitter 23. After passing through the sensor lens 33, the converted beam is detected by the second receiving portion 35-2 (FIG. 2) of the photodetector 35.

Lastly, description will be made as regards operation in a case where the HD-DVD is used as the optical disc. In this event, only the blue laser diode (the third laser diode) 12 (HD-LD) is put into an active state while the first laser diode (CD-LD) and the second laser diode (DVD-LD) in the one-chip type laser diode 11 are put into an inactive state.

The third laser beam irradiated from the blue laser diode (the third laser diode) 12 (HD-LD) passes through the second diffraction grating 17 at which the third laser beam is separated to three laser beams in order to carry out the tracking control, the focusing control, and the tilting control. Thereafter, the three laser beams are reflected by the first beam splitter 21 and enter the second beam splitter 23 as incoming beams. In the incoming beams, a part passes through the second beam splitter 23 and its through-beam is received by the front monitor 25. At any rate, the front monitor 25 monitors a light-emitting amount of the third laser beam which passes through the second beam splitter 23. On the other hand, in the incoming beams, a reflected beam, which is reflected by the second beam splitter 23, is reflected by the rising mirror 27 upward. When the laser beam reflected by the rising mirror 27 passes through the collimator lens 29, the laser beam, which is a diverged beam, is collimated into a collimated beam. The collimated beam enters the objective lens 31. Passed through the objective lens 31, the laser beam is converged and irradiated on a signal recording surface of the optical disc (the HD-DVD).

Reflected by the signal recording surface of the optical disc (the HD-DVD), a reflected beam (the third return beam) passes through the objective lens 31 and becomes a converged beam after passing through the collimator lens 29. After reflected by the rising mirror 27, the converged beam passes through the second beam splitter 23. After passing through the sensor lens 33, the converted beam is detected by the second receiving portion 35-2 (FIG. 2) of the photodetector 35.

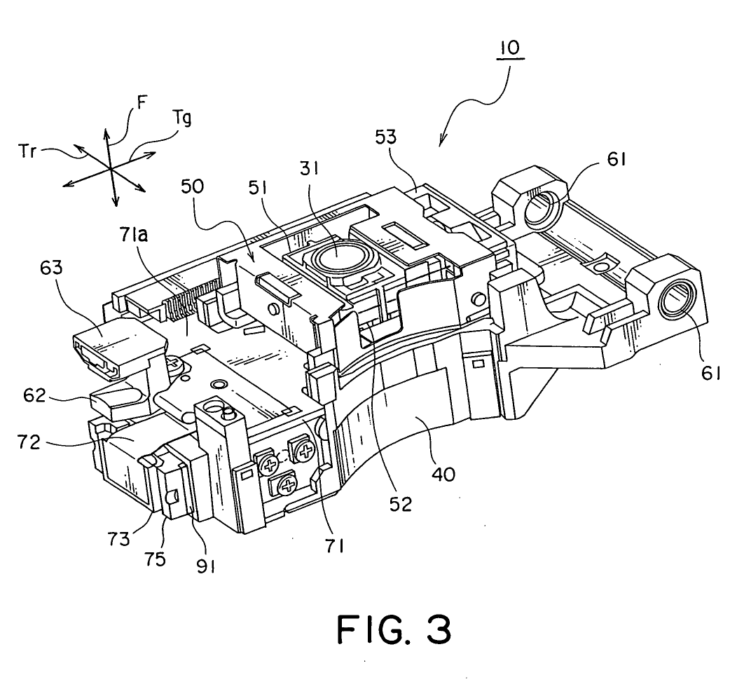

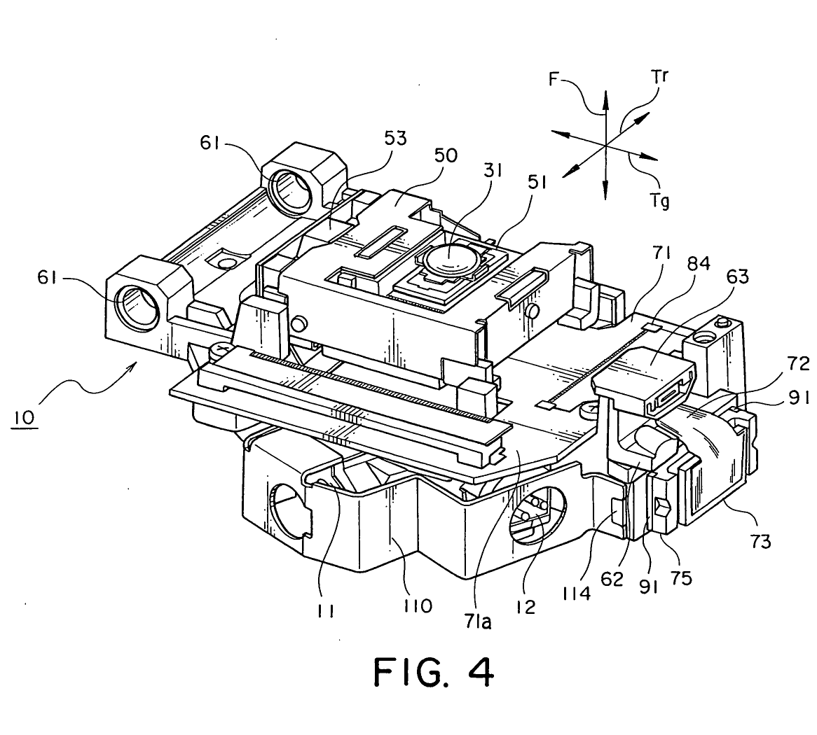

Referring to FIGS. 3 and 4, the description further will proceed to the three-wavelength handling optical pickup unit 10. Hereinafter, the three-wavelength handling optical pickup unit 10 is merely called an optical pickup unit.

The optical pickup unit 10 comprises an optical base 40. On the optical base 40, an objective lens driving device 50 is mounted through an OPU circuit board 71. The optical base 40 is movably mounted to guide bars (not shown) in a radial direction (a tracking direction Tr) of the optical disc loaded in an optical disc drive. In other words, the optical pickup unit 10 is sled-moved in a predetermined disc's radial direction (the tracking direction Tr) by a pickup driving portion (not shown). The pickup driving portion comprises, as the guide bars, a main shaft (not shown) and a subsidiary shaft (not shown) which sled-movably support the optical pickup unit 10 at both ends thereof in the predetermined disc's radial direction (the tracking direction Tr). Both of the main shaft and the subsidiary shaft are disposed so as to substantially extend in parallel with the predetermined disc's radial direction (the tracking direction Tr).

The optical pickup unit 10 comprises an engaging portion (an engaging hole) 61 engaged with the main shaft and a U-shaped sliding contact portion 62 in cross section that is slidably supported by the subsidiary shaft. In the example being illustrated, the sliding contact portion 62 has an upper sliding contact part into which a cap 63 is fitted. Between the cap 62 and a lower sliding contact part of the sliding contact portion 62, the subsidiary shaft is sandwiched.

The objective lens driving device 50 comprises an objective lens holder 51 having a shape of substantially rectangular parallelepiped. The objective lens holder 51 has a lens fitting portion for fitting the objective lens 31 at a center thereof. The illustrated objective lens driving device 50 is a symmetry type where coils (not shown) and a magnetic circuit (not shown) including magnets are symmetrically disposed with respect to the objective lens 31 as a center. The objective lens driving device 50 of the symmetry type comprises the objective lens holder 51 for holding the objective lens 31, a focusing coil (not shown) wound around the objective lens holder 51, tracking coils (not shown) affixed to the objective lens holder 51 at outer sides in a tangential direction Tg of the optical disc, and tilting coils (not shown) affixed to the objective lens holder 51 at both sides in a radial direction of the optical disc. These coils are partly located in gaps of the magnetic circuit. With this structure, the objective lens driving device 50 of the symmetry type is capable of finely controlling a position and an inclination of the objective lens 31 by controlling currents flowing through the respective coils.

More specifically, the objective lens driving device 50 elastically supports the objective lens holder 51 for holding the objective lens 31 at a damper base 53 via six suspension wires 52. In other words, the objective lens holder 51 is supported at the damper base 53 by the six suspension wires 52 which extend in the tangential direction Tg. The six suspension wires 52 are used also as wires for electrically connecting the above-mentioned various coils with an external circuit, namely, a driving circuit (not shown) for the objective lens driving device 50. In the objective lens holder 51, the tilting coils, the focusing coil, and the tracking coils are wound in the manner which is described above. By suitably controlling currents flowing through these coils, the objective lens holder 51 tilts in the tracking direction Tr (rotates around an axis in parallel to the tangential direction Tg), shifts in the tracking direction Tr, or shifts in the focusing direction F on the basis of relationships between the currents and magnetic fields produced by the magnetic circuit consisting of a yoke and the magnets.

On an upper surface of the optical base 40, the OPU circuit board 71 is mounted. On the OPU circuit board 71, the objective lens driving device 50 is fixed on the optical base 40 at four corners thereof by using a UV adhesive with a space left therebetween.

The photodetector 35 is mounted on a PD circuit board 73 and is fixed to the outer side wall of the optical base 40 by using a UV adhesive 91 with the photodetector 35 held by a PD holder 75.

As shown in FIG. 2, the photodetector 35, which receives the reflected beam (the return beam) from the optical disc, comprises the lot of photo-diodes. Received by the lot of photo-diodes, received signals are processed in a processing circuit (not shown) of the photodetector 35 and are sent to the OPU circuit board 71 via a PD flexible printed circuit board (FPC) 72.

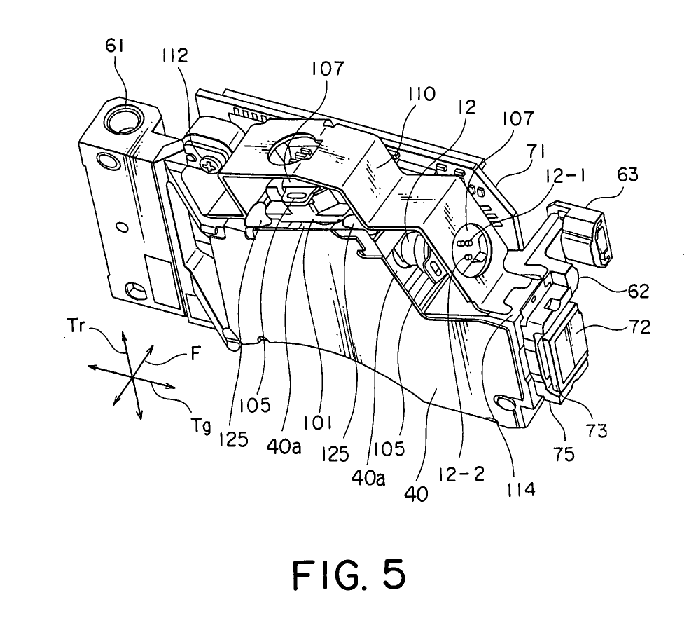

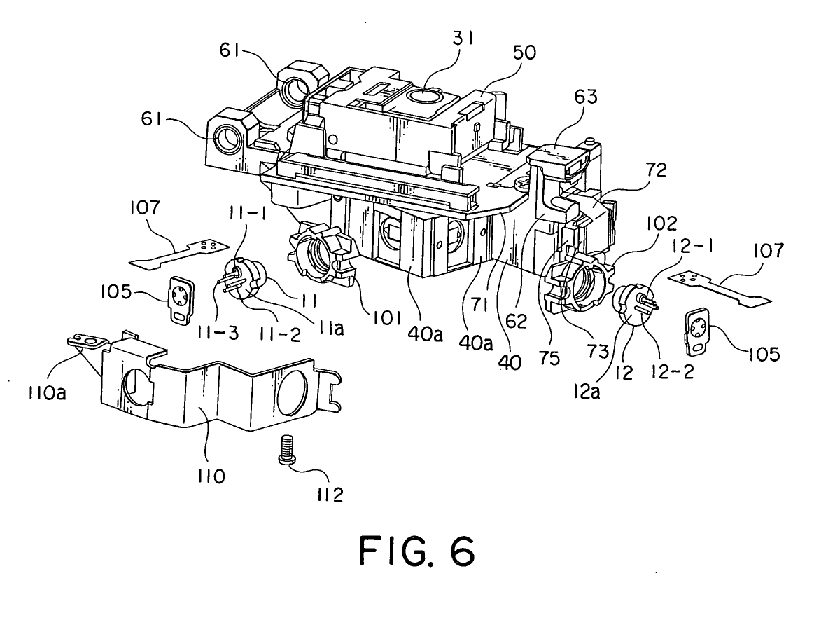

Referring to FIGS. 5 and 6 in addition to FIG. 4, the one-chip type laser diode 11 is mounted on an outer wall 40a of the optical base 40 through a first LD holder 101 using a UV adhesive agent (not shown). Likewise, the blue laser diode 12 is mounted on the outer wall 40a of the optical base 40 through a second LD holder 102 using the UV adhesive agent. In other words, the one-chip type laser diode 11 is mounted on the outer wall 40a of the optical base 40 with the one-chip type laser diode 11 held in the first LD holder 101 while the blue laser diode 12 is mounted on the outer wall 40a of the optical base 40 with the blue laser diode 12 held in the second LD holder 102.

The one-chip type laser diode 11 has four terminals which project into a rear surface side from a base portion 11a thereof. Among the four terminals, three terminals are a CD-LD terminal 11-1, a DVD-LD terminal 11-2, and a GND terminal 11-3 and a remaining one is a dummy terminal. On the other hand, the blue laser diode 12 has three terminals which project into a rear surface side from a base portion 12a thereof. Among the three terminals, two terminals are an LD terminal 12-1 and a GND terminal 12-2 and a remaining one is a dummy terminal.

Each of the one-chip type laser diode 11 and the blue laser diode 12 is electrically connected to a laser diode driver (LDD) (not shown) on the OPU circuit board 71 through a short-land flexible printed board 105 according to this invention and a LD flexible printed board 107.

The short-land flexible printed board 105 for use in the blue laser diode 12 is a short-land flexible printed board on which conductive patterns (which will later be described) are formed. The conductive patterns enable to short-circuit between the LD terminal 12-1 and the GND terminal 12-2 of the blue laser diode 11 using solder (which will later be described) at a position apart from the LD terminal 12-1. On the other hand, the short-land flexible printed board 105 for use in the one-chip type laser diode 11 is a short-land flexible printed board on which the conductive patterns (which will later be described) are formed. The conductive patterns enable to short-circuit among the CD-LD terminal 11-1, the DVD-LD terminal 11-2, and the GND terminal 11-3 of the one-chip type laser diode 11 using solder (which will later be described) at a position apart from the CD-LD terminal 11-1 and the DVD-LD terminal 11-2.

The LD flexible printed board 107 for use in the blue laser diode 12 is for electrically connecting the LD terminal 12-1 and the GND terminal 12-2 of the blue laser diode 12 with the laser diode driver on the OPU circuit board 71. The LD flexible printed board 107 for use in the one-chip type laser diode 11 is for electrically connecting the CD-LD terminal 11-1, the DVD-LD terminal 11-2, and the GND terminal 11-3 of the one-chip type laser diode 11 with the laser diode driver on the OPU circuit board 71.

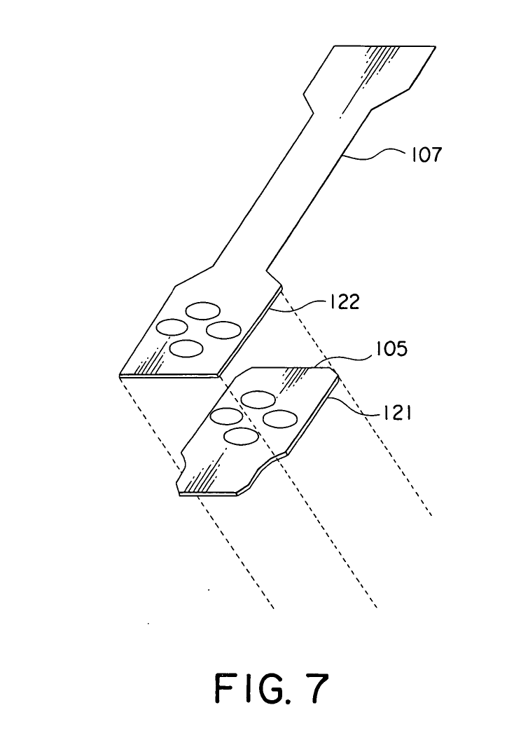

Referring to FIG. 7 also, the short-land flexible printed board 105 for use in the blue laser diode 12 is disposed between the base portion 12a of the blue laser diode 12 and the LD flexible printed board 107. More specifically, a first reinforcing board 121 lies between the base portion 12a of the blue laser diode 12 and the short-land flexible printed board 105 while a second reinforcing board 122 lies between the short-land flexible printed board 105 and the LD flexible printed board 107.

Similarly, the short-land flexible printed board 105 for use in the one-chip type laser diode 11 is disposed between the base portion 11a of the one-chip type laser diode 11 and the LD flexible printed board 107. More specifically, the first reinforcing board 121 lies between the base portion 11a of the one-chip type laser diode 11 and the short-land flexible printed board 105 while the second reinforcing board 122 lies between the short-land flexible printed board 105 and the LD flexible printed board 107.

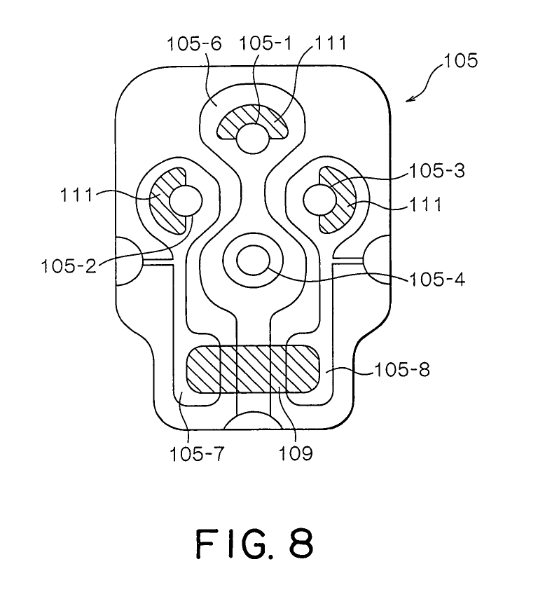

Referring to FIG. 8, the description will proceed to the short-land flexible board 105. The short-land flexible board 105 has first through fourth through holes 105-1, 105-2, 105-3, and 1054 for passing through the four terminals of the laser diode (the blue laser diode 12 or the one-chip type laser diode 11).

It will be assumed that the laser diode is the blue laser diode 12. In this event, the LD terminal 12-1 passes through the first through hole 105-1, the GND terminal 12-2 passes through the second through hole 105-2, and the remaining dummy terminal passes through the third through hole 105-3. It will be presumed that the laser diode is the one-chip type laser diode 11. In this event, the CD-LD terminal 11-1 passes through the first through hole 105-1, the DVD-LD terminal 11-2 passes through the second through hole 105-2, the GND terminal 11-3 passes through the third through hole 105-3, and the remaining dummy terminal passes through the fourth through hole 105-4.

The short-land flexible printed board 105 has first through third conductive patterns 105-6, 105-6, and 105-7. The first conductive pattern 105-6 covers around the first through hole 105-1 and extends downwards. The second conductive pattern 105-7 covers around the second through hole 105-2 and extends downwards. The third conductive pattern 105-7 covers around the third through hole 103-3 and extends downwards.

It is possible to short-circuit between the terminals of the laser diode that pass through the first through the third through holes 105-1 to 105-3 by applying solder 109 over the first through the third conductive patterns 105-6 to 105-8 at a lower portion and by applying solder 111 to the first through the third conductive patterns 105-6 to 105-8 around the first through the third through holes 105-1 to 105-3.

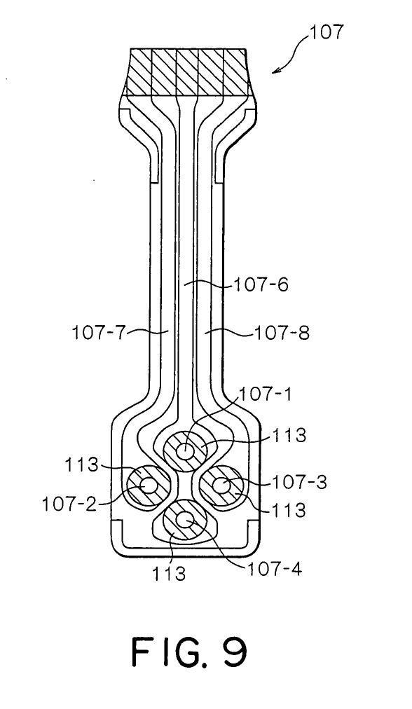

Referring to FIG. 9, the description will proceed to the LD flexible printed board 107. The LD flexible printed board 107 has first through fourth through holes 107-1, 107-2, 107-3, and 107-4 for passing through the four terminals of the laser diode (the blue laser diode 12 or the one-chip type laser diode 11).

It will be assumed that the laser diode is the blue laser diode 12. In this event, the LD terminal 12-1 passes through the first through hole 107-1, the GND terminal 12-2 passes through the second through hole 107-2, and the remaining dummy terminal passes through the third through hole 107-3. It will be presumed that the laser diode is the one-chip type laser diode 11. In this event, the CD-LD terminal 11-1 passes through the first through hole 107-1, the DVD-LD terminal 11-2 passes through the second through hole 107-2, the GND terminal 11-3 passes through the third through hole 107-3, and the remaining dummy terminal passes through the fourth through hole 107-4.

The LD flexible printed board 107 has first through third conductive patterns 107-6, 107-7, and 107-8. The first conductive pattern 107-6 covers around the fourth through hole 107-4 and the first through hole 107-1 and extends upwards. The second conductive pattern 107-7 covers around the second through hole 107-2 and extends upwards. The third conductive pattern 107-8 covers around the third through hole 107-3 and extends upwards.

The terminals of the laser diode that pass through the first through the third through holes 107-1 to 107-3 are electrically connected to the first through the fourth conductive patterns 107-6 to 107-8, respectively, by applying solder 113 to the first through the fourth conductive patterns 107-6 to 107-8 around the first through the third through holes 107-1 to 107-3. In addition, inasmuch as the solder 113 is applied to the first conductive pattern 107-6 around the fourth through hole 1074, the terminals of the laser diode that pass through the first through hole 107-1 and the fourth through hole 107-4 are short-circuited with each other.

In the manner which is described above, the short-land flexible printed board 105 is mounted on the base portion of the laser diode (the one-chip type laser diode 11 or the blue laser diode 12) through the first reinforcing plate 121 while the LD flexible printed board 107 is mounted on the short-land flexible printed board 105 through the second reinforcing plate 122. In this state, the lower portion of the short-land flexible printed board 105 is exposed and the first through the third conductive patterns 105-6 to 105-8 are exposed to the outside.

During between a time instant where the blue laser diode 12 is mounted on the outer wall 40a of the optical base 40 with it held in the second LD holder 102 and a time instant where the blue laser diode 12 is electrically connected to the laser diode driver (LDD) (not shown) on the OPU circuit board 71, the LD terminal 12-1 and the GND terminal 12-2 of the blue laser diode 12 are short-circuited by the solder 109 on the short-land flexible board 105. It is therefore possible to prevent the blue laser diode 12 from destroying from the static electricity. Thereafter, the blue laser diode 12 and the laser diode driver LDD on the OPU circuit board 71 are electrically connected to each other through the LD flexible printed board 107. And then, the LD terminal 12-1 and the GND terminal 12-2 of the blue laser diode 12 are opened by melting the solder 109 and sucking the solder 109.

Inasmuch as the position where the solder 109 is applied or melted is apart from the LD terminal 12-1 of blue laser diode 12, heat does not transfer to an excessive degree on applying or melting the solder 109. Accordingly, it is possible to prevent the blue laser diode 12 from seriously affecting.

Likewise, during between a time instant where the one-chip type laser diode 11 is mounted on the outer wall 40a of the optical base 40 with it held in the first LD holder 101 and a time instant where the one-chip type laser diode 11 is electrically connected to the laser diode driver LDD (not shown) on the OPU circuit board 71, the CD-LD terminal 11-1, the DVD-LD terminal 11-2, and the GND terminal 11-3 of the one-chip type laser diode 11 are short-circuited by the solder 109 on the short-land flexible printed board 105. It is therefore possible to prevent the one-chip type laser diode 11 from destroying from the static electricity. Thereafter, the one-chip type laser diode 11 and the laser diode driver LDD on the OPU circuit board 71 are electrically connected to each other through LD flexible printed board 107. And then, the CD-LD terminal 11-1, the DVD-LD terminal 11-2, and the GND terminal 12-2 of the one-chip type laser diode 11 are opened by melting the solder 109 and sucking the solder 109.

Inasmuch as the position where the solder 109 is applied or melted is apart from the CD-LD terminal 11-1 and the DVD-LD terminal 11-2 of the one-chip type laser diode 11, heat does not transfer to the CD-LD terminal 11-1 and the DVD-LD terminal 11-2 of the one-chip type laser diode 11 to an excessive degree. Accordingly, it is possible to prevent the one-chip type laser diode 11 from adversely affecting.

As shown in FIGS. 4-6, the optical pickup unit 10 comprises a side cover 110 for covering the one-chip type laser diode 11 and the blue laser diode 12. The side cover 110 has an end 110a fixed to the optical base 40 by a screw 112 and another end fixed to the optical base 40 by a UV adhesive agent 114. The side cover 110 and the optical base 40 are closed to each other with gaps at which a silicone resin 125 is affixed so as to connect among the first LD holder 101, the side cover 110, and the optical base 40 and to connect among the second LD holder 102, the side cover 110, and the optical base 40. The silicone resin 125 serves as a radiating resin.

The side cover 110 is for preventing a person (a manufacturing person) from directly being contact with LD terminals (the CD-LD terminal 11-1, the DVD-LD terminal 11-2, the LD terminal 12-1) of the one-chip type laser diode 11 and the blue laser diode 12 on handling the optical pickup unit 10 in question. It is therefore possible to prevent the one-chip type laser diode 11 and the blue laser diode 12 from destroying from static electricity accumulated in the person. In addition, the side cover 110 acts not only to protect the laser diodes (the one-chip type laser diode 11, the blue laser diode 12) but also to reduce radiation of undesired noises to outside.

In addition, inasmuch as the radiating resin 125 such as the silicone resin is affixed among the LD holders (the first LD holder 101, the second LD holder 102), the side cover 110, and the optical base 40, it is possible to effectively dissipate heat generated by the laser diodes (the one-chip type laser diode 11, the blue laser diode 12). That is, it is possible to dissipate the heat to the optical base 40 side through the side cover 110 or to dissipate the heat from the side cover 110 to the outside.

While this invention has thus far been described in conjunction with a preferred embodiment thereof, it will now be readily possible for those skilled in the art to put this invention into various other manners without departing from the scope of this invention. For example, although description is exemplified in a case where the HD-DVD is used as the optical disc for the blue laser beam, a Blu-ray disc may be used in lieu of the HD-DVD. Needless to say, this invention is not restricted to the three-wavelength handling optical pickup units, this invention may be applicable to various types of optical pickup units.

What is claimed is:

1. An optical pickup unit (OPU) comprising:
an optical base;
at least one laser diode (LD) mounted on an outer wall of said optical base, said laser diode comprising a base portion and an LD terminal and a GND terminal which extend from said base portion to a rear surface side: and
a short-land flexible printed board on which conductive patterns are formed, said conductive patterns enabling to short-circuit between the LD terminal and the GND terminal of said laser diode using solder at a position apart from said LD terminal.

2. The optical pickup unit as claimed in claim 1, said optical pickup unit comprising an OPU circuit board mounted on said optical base and an LD flexible printed board for electrically connecting the LD terminal and the GND terminal of said laser diode with said OPU circuit board,
wherein said short-land flexible printed board is disposed between the base portion of said laser diode and said LD flexible printed board.

3. The optical pickup unit as claimed in claim 2, wherein said optical pickup unit further comprises:
a first reinforcing plate lying between the base portion of said laser diode and said short-land flexible printed board; and
a second reinforcing plate lying between said short-land flexible printed board and said LD flexible printed board.

4. The optical pickup unit as claimed in claim 1, wherein said optical pickup unit further comprises a side cover for covering said laser diode so as to be directly not contact with said LD terminal of said laser diode.

5. The optical pickup unit as claimed in claim 4, wherein said optical pickup unit comprises:
a LD holder for holding said laser diode to mount said laser diode on the outer wall of said optical base; and
a radiating resin applied among said LD holder, said side cover, and said optical base.

6. The optical pickup unit as claimed in claim 1, wherein said optical pickup unit comprises a three-wavelength holding optical pickup unit which is enable to carry out recording or reproducing for three kinds of optical recoding media by selectively using three kinds of laser beams having different wavelengths.
